(19) United States
(12) Patent Application Publication
(10) Pub. No.: US 2020/0167819 A1
(43) Pub. Date: May 28, 2020

(54) ANALYTICS SYSTEM AND METHOD FOR ASSESSING MULTI-CHANNEL CAUSAL IMPACT OF THE INTRODUCTION OF NEW DIGITAL CHANNELS

(71) Applicant: TapClicks, Inc., Los Altos Hills, CA (US)

(72) Inventors: Gautham Ramachandran, Campbell, CA (US); Noah Ezra Jacobson, San Jose, CA (US); Syed Mohtashim Ahmed, San Jose, CA (US); Babak Hedayati, Los Altos Hills, CA (US)

(21) Appl. No.: 16/202,224

(22) Filed: Nov. 28, 2018

(51) Int. Cl. G06Q 30/02; G06F 16/953

(52) U.S. Cl. CPC G06Q 30/0243; G06F 16/953

(57) ABSTRACT

A method for identifying causal impact of introducing digital channels and enhancements, the method comprising receiving data corresponding to online interactions with consumers based on online monitoring of an advertiser, identifying digital channels associated with the online interactions with consumers, identifying online metrics for assessment associated with the digital channels, determining a Bayesian time-series model for the data based on the identified online metrics, analyzing causality impact of an intervention for one or more paid digital and organic digital channels using the Bayesian time-series model, identifying optimal pre- and post-intervention assessment time periods based on causality impact of the one or more paid digital and organic digital channels that is statistically significant, and generating a report including a causality assessment of the online metrics for the one or more paid digital and organic digital channels by period based on the causality impact during the optimal pre- and post-intervention time periods.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

### Field of the Invention

This application generally relates to analysis of marketing campaigns, and in particular, measurement of impact across digital marketing channels causal modeling, marketing attribution and intervention analysis of a marketing channel.

### Description of the Related Art

A marketing person may run a marketing campaign and want to know how the campaign has actually helped to increase, for example, website traffic, sign ups, conversions, or other metrics. One can just compare the measures before the marketing campaign and after the marketing campaign, but in reality, it is difficult to measure such an impact in the real world because there are many attributes that can influence the outcome. Generally, users are likely to have more than one interaction with a marketing channel (e.g., paid search marketing, online display advertising, social media marketing, etc.) before a purchase or an engagement decision is made. As such, a plurality of marketing channel interactions can drive sales and conversions. However, from an analytical perspective, causal impact is difficult to track at an individual entity level. Causality analysis in general requires more judgement than evaluation of randomized test/control experiments as setting up clean experiments is not feasible in many real-world scenarios. Therefore, there is a need to derive such using relevant methodologies and approaches.

### SUMMARY OF THE INVENTION

The present invention provides a method, system, and non-transitory computer-readable media for identifying causal impact of adding digital channels. According to one embodiment, the method comprises receiving data corresponding to online interactions with consumers based on online monitoring of an advertiser, identifying digital channels associated with the online interactions with consumers, identifying online metrics for assessment associated with the digital channels, determining a Bayesian time-series model for the data based on the identified online metrics, analyzing causality impact of an intervention for one or more paid digital and organic digital channels using the Bayesian time-series model, identifying optimal pre- and post-intervention assessment time periods based on causality impact of the one or more paid digital and organic digital channels that is statistically significant, and generating a report including a causality assessment of the online metrics for the one or more paid digital and organic digital channels by period based on the causality impact during the optimal pre- and post-intervention time periods.

Analyzing causality impact may further comprise determining whether the impact is statistically significant at 95% significance. In one embodiment, wherein a given online metric for assessment is click-through-rate, the Bayesian time-series model may be based on using clicks as a response variable adjusted for control online metrics such as impressions, spend, and rank, using dynamic time-warping, in addition to the identification of the optimal pre- and post-intervention assessment time periods. Generating the report including the causality assessment may further comprise estimating the causality assessment of the online metrics for at least two paid digital channels and one organic digital channel. In another embodiment, identifying the optimal pre- and post-intervention assessment time periods may further comprise assessing the causality impact iteratively over incremental 30-day periods before and after the intervention.

According to one embodiment, the system comprises a memory device having executable instructions stored therein, and a processing device, in response to the executable instructions, configured to receive data corresponding to online interactions with consumers based on online monitoring of an advertiser, identify digital marketing channels associated with the online interactions with consumers, identify online metrics for assessment associated with the digital marketing channels, determine a Bayesian time-series model for the data based on the identified online metrics, analyze causality impact of a marketing intervention for one or more paid digital marketing and organic digital marketing channels using the Bayesian time-series model, identify optimal pre- and post-intervention assessment time periods based on causality impact of the one or more paid digital marketing and organic digital marketing channels that is statistically significant, and generate a report including a causality assessment of the online metrics for the one or more paid digital marketing and organic digital marketing channels by period based on the causality impact during the optimal pre- and post-intervention time periods.

The processing device analyzing causality impact may further comprise the processing device determines whether the impact is statistically significant at 95% significance. In one embodiment, wherein a given online metric for assessment is click-through-rate, the Bayesian time-series model may be based on using clicks as a response variable matched on control online metrics, and spend and rank using dynamic time warping for the identification of the optimal pre- and post-intervention assessment time periods. In another embodiment, the processing device generating the report including the causality assessment may further comprise the processing device estimates the causality assessment of the online metrics for at least two paid digital marketing channels and one organic digital marketing channel. In yet another embodiment, wherein the processing device identifies the optimal pre- and post-intervention assessment time periods further comprises the processing device assesses the causality impact iteratively over incremental 30-day periods before and after the marketing intervention.

According to one embodiment, the non-transitory computer-readable media comprises program code that when executed by a programmable processor causes execution of a method for identifying causal impact of adding digital marketing channels. The computer-readable media comprising computer program code for receiving data corresponding to online interactions with consumers based on online monitoring of an advertiser, computer program code for identifying digital marketing channels associated with the online interactions with consumers, computer program code for identifying online metrics for assessment associated with the digital marketing channels, computer program code for determining a Bayesian time-series model for the data based on the identified online metrics, computer program code for analyzing causality impact of a marketing intervention for one or more paid digital marketing and organic digital marketing channels using the Bayesian time-series model, computer program code for identifying optimal pre- and post-intervention assessment time periods based on causality impact of the one or more paid digital marketing and organic digital marketing channels that is statistically significant, and computer program code for generating a report including a causality assessment of the online metrics for the one or more paid digital marketing and organic digital marketing channels by period based on the causality impact during the optimal pre- and post-intervention time periods.

The computer program code for analyzing causality impact may further comprise computer program code for determining whether the impact is statistically significant at 95% significance. In one embodiment, wherein a given online metric for assessment is click-through-rate, the Bayesian time-series model is based on using clicks as a response variable matched on control online metrics such as impressions, spend, and rank using dynamic time warping in addition to the identification of the optimal pre- and post-intervention assessment time periods. In another embodiment, the computer program code for generating the report including the causality assessment further comprises computer program code for estimating the causality assessment of the online metrics for at least two paid digital marketing channels and one organic digital marketing channel. The computer program code for identifying the optimal pre- and post-intervention assessment time periods may further comprise computer program code for assessing the causality impact iteratively over incremental 30-day periods before and after the marketing intervention.

### BRIEF DESCRIPTION OF THE DRAWINGS

The invention is illustrated in the figures of the accompanying drawings which are meant to be exemplary and not limiting, in which like references are intended to refer to like or corresponding parts.

FIG. 1 illustrates a computing system according to an embodiment of the present invention.

FIG. 2 illustrates a block diagram of components within an exemplary networked computer system according to an embodiment of the present invention.

FIG. 3 illustrates a flowchart of a method for identifying causal impact of adding marketing channels according to an embodiment of the present invention.

FIG. 4 illustrates identified causality for search query impressions for an organic channel for a volume based online metric according to an embodiment of the present invention.

FIG. 5 illustrates identified causality for a paid channel for a rate based online metric according to an embodiment of the present invention.

FIG. 6 illustrates identified causality for a channel for a metric for multiple advertisers according to an embodiment of the present invention.

FIG. 7 illustrates posterior inference by causality assessment according to an embodiment of the present invention.

FIG. 8 illustrates final causality assessment for an advertiser according to an embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Techniques are disclosed for evaluating the effect of a digital marketing channel that forms part of a multichannel marketing campaign. The present application discloses a system and a method for causal modeling and marketing attribution using a sub-class of Bayesian structural time-series models, hereinafter called “Bayesian time-series models,” and dynamic time warping to assess impact of new digital marketing channel introduction across paid and organic digital marketing channels iteratively to arrive at optimal pre- and post-intervention period of analysis for selected online metrics and channels. In particular, online metrics may be pre-screened and assessed for causal impact to measure the impact of new marketing channels introduction across paid and organic channels. Marketing attribution is the practice of determining the role that marketing channel play in informing and influencing a user's path to conversion. Examples of marketing channels include Google Adwords, Facebook Ads, and Adobe SiteCatalyst. Marketing attribution can provide visibility in how marketing affects the entire customer engagement cycle.

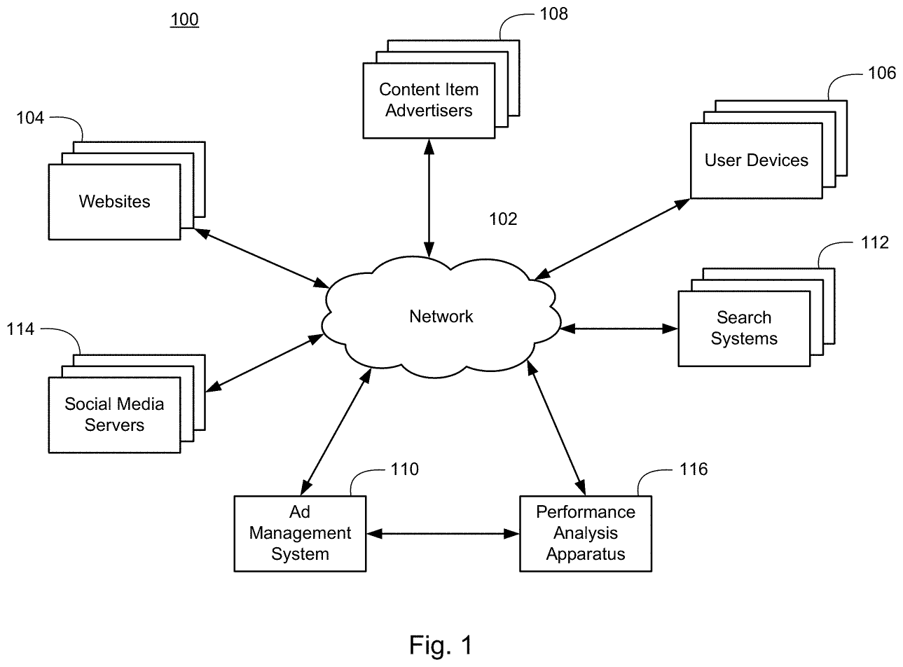

FIG. 1 presents a block diagram of a computing system in which a content item management system manages marketing services according to one embodiment. The system 100 includes a network 102, such as a local area network (LAN), a wide area network (WAN), the Internet, or a combination thereof. The network 102 can connect web sites 104, user devices 106, content item advertisers 108, and an ad management system 110. The example environment 100 can include a plurality of web sites 104, user devices 106, and content item advertisers 108.

A user device 106 can include a user application, such as a web browser, to facilitate the sending, requesting and receiving of data from a website 104 over the network 102. User devices 106 may comprise computing devices, such as desktop computers, television devices, terminals, laptops, personal digital assistants (PDA), cellular phones, smartphones, tablet computers, e-book readers, smart watches and wearable devices, or any computing device having a central processing unit and memory unit capable of sending and receiving data over the network 102. A website 104 can include one or more resources associated with a domain name and hosted by one or more servers. An exemplary website may include a collection of web pages that can contain text, images, multimedia content, and programming elements, such as scripts.

Search systems 112 may comprise one or more processing components disposed on one or more processing devices or systems in a networked environment. The search systems 112 are operative to receive search requests and process the requests to generate search results to the user devices 106 across the network 102. The plurality of search systems 112 may facilitate searching of resources from websites 104 by crawling and indexing the resources provided on the websites 104. User devices 106 can submit search queries to the search systems 112 over the network 102. In response, the search systems 112 may access an index to identify resources that are relevant to the search query. The search systems 112 may identify the resources that are responsive to a query including one or more keywords and provide information about the resources as search results to the user devices 106. The search query can also be provided to the ad management system 110 to facilitate identification of content items that are relevant to the search query. Based on data in the search query, the ad management system 110 can select content items that are eligible to be provided in response to the request. For example, eligible content items can include content items having characteristics matching the characteristics that are identified as relevant to specified resource keywords or search terms.

The ad management system 110 may be coupled to a performance analysis apparatus 116 to determine performance measures that specify measures of online user interactions with content items. User interaction data representing online user interactions with presented content items can be collected by performance analysis apparatus 116. Data representing selection of a content item can be stored in the performance analysis apparatus 116. In some embodiments, the data is stored in response to a request for a web page that is linked to by the content item. For example, the user selection of the content item can initiate a request for presentation of a web page that is provided by (or for) the content item advertiser 108.

The performance analysis apparatus 116 may include a networked computing device that can measure, for each content item advertiser 108, user interactions with content items that are provided by the content item advertiser 108 and marketing channeling online metric performance. The performance analysis apparatus 116 can store data that specifies a number of impressions, click-through-rate (CTR), page views, visits, conversions and other online metrics for each content item. Using the measurements, the content item advertiser can analyze whether certain marketing channels are producing a causal effect on certain online metrics. The campaign performance can generate a report of measures for a content item over a specified period of time. In turn, the content item advertiser 108 can adjust campaign parameters that control marketing actions. New opportunities can be identified by characterizing a content item advertiser's current digital marketing channel strategy based on causal impact, and then increasing and/or shifting efforts. For example, in cases where the magnitude of impact for a digital marketing channel opportunity is small, it can be advantageous for a content item advertiser to know that the effort/spend on these marketing channel activities is not very impactful. On the other hand, in cases where the magnitude of impact for a digital marketing channel is large, a content item advertiser can, for example, modify the spend/effort on these marketing channel activities.

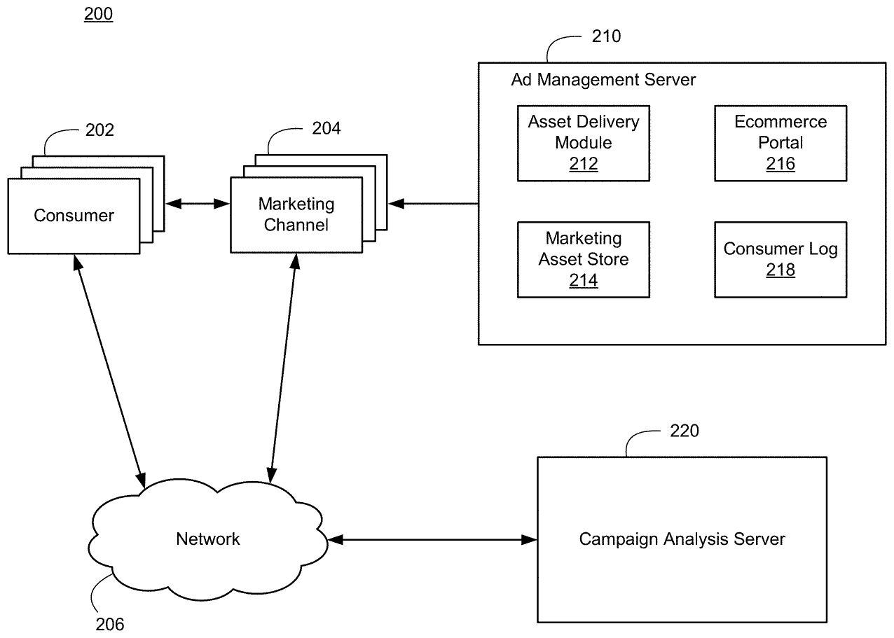

FIG. 2 presents a block diagram of components within an exemplary networked computer system 200 that can be used to implement certain embodiments disclosed herein. In the illustrated embodiment, networked computer system 200 is capable of evaluating the causal effect of a marketing channel that forms part of a multichannel marketing campaign. Interactions between a plurality of consumers 202 and ad management server 210 may occur through one or more marketing channels 204 via network 206. One or more marketing channels 204 can be used to interact with one or more consumers 202, and vice versa.

In one embodiment ad management server 210 comprises one or more central processing units and memory configured to manage one or more marketing campaigns with functions including, hosting marketing assets, responding to requests to deliver the hosted assets to consumers 202 via marketing channels 204, and providing ecommerce services to consumers 202. Marketing assets may be stored in marketing asset store 214. Ad management server 210 includes an asset delivery module 212 that is capable of managing the delivery of the marketing assets to consumers 202 via marketing channels 204. Ad management server 210 may also be configured to provide ecommerce services to consumers 202 via an ecommerce portal 216. One or more of the marketing assets distributed to consumers 202 may include a hyperlink that enables consumers 202 to access the services provided by ecommerce portal 216.

Ad management server 210 includes a consumer log 218 that may be configured to maintain a record of advertiser to consumer interactions. Consumer log 218 may record marketing channel and consumer activity associated with asset delivery module 212 and ecommerce portal 216. Consumer log 218 can also be configured to record consumer interactions by, for example, recording whether a consumer clicks on a hyperlink or banner advertisement. Consumer log 218 may also maintain a record of whether a particular consumer has previously contacted the advertiser (e.g., via email, social media, chat messages, telephone), or the advertiser's website. Consumer log 218 can use data tracking and monitoring techniques to collect information associated with the online interactions that occur between advertiser and consumers.

Campaign analysis server 220 may comprise one or more computing devices that are configured to provide a range of analytical services that may be used to evaluate the causal effect of a marketing channel that forms part of a multichannel marketing campaign. Campaign analysis server 220 may comprise, for example, one or more devices selected from a desktop computer, a laptop computer, a workstation, a tablet computer, a smartphone, a handheld computer, a set-top box, a server, or any other suitable computing device. Campaign analysis server 220 may include one or more software modules configured to implement certain of the functionalities disclosed herein, as well as hardware configured to enable such implementation. Hardware and software components may include, among other things, a processor, a memory, an operating system, and a communications adaptor.

Campaign analysis server 220 is coupled to network 206 to allow for communications with ad management server 210. Campaign analysis server 220 may be configured to estimate causal impact based on an observed collection of advertiser to consumer interactions, such as may be recorded in consumer log 218. The estimated causal impact can be used to predict a measurable effect that can be attributed to a particular marketing channel. The campaign analysis server 220 may be configured to generate numerical and graphical representations of, for example, how conversions are attributed to a plurality of marketing channels.

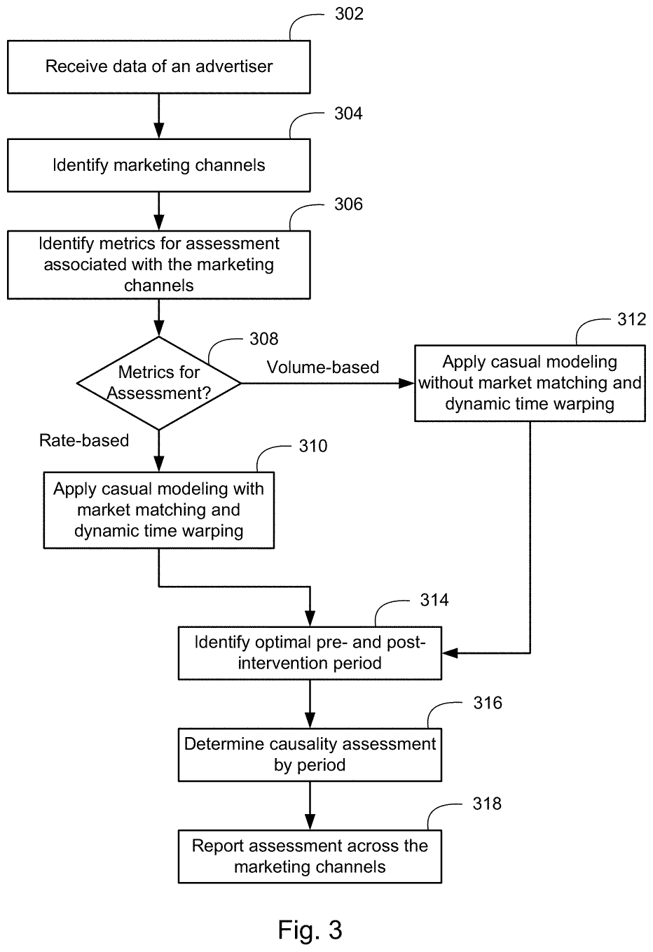

FIG. 3 presents a method for identifying causal impact of adding marketing channels according to an embodiment of the present invention. An advertiser may desire to analyze its usage of digital marketing channels and their effectiveness using a performance analysis system. Data of an advertiser is received for measuring impact of adding a new digital marketing channel, step 302. For example, the data may include online interactions between the advertiser and consumers. The performance analysis system may be configured by the advertiser to monitor and collect a data set associated with its sales, traffic, visits, and other online marketing online metrics.

Marketing channels are identified, step 304. According to one embodiment, causal impact may be assessed across identified paid and organic digital marketing channels as shown in Table 1. Table 1 includes a framework that identifies multi-channel impact of marketing channel intervention across paid and organic digital marketing channels that can be selected on the performance analysis system.

TABLE 1

| Marketing Channel | Traffic Category | Metric 1 | Metric 2 |
|---|---|---|---|
| Google Adwords | Brand Terms (search | Impressions | |
| | only) | | |
| Google Adwords | Non-Brand Terms | CTR | |
| | (search only) | | |
| Google Adwords | Display Only | CTR | |
| Google Analytics | All Traffic | Visits | Visits by |
| | | | Direct/Organic source |
| Facebook Insights | All Traffic | Page views | |
| Facebook Ads | All Traffic | CTR | |
| Google WebMaster | All Traffic | Search query | |
| Tools | | impressions | |
| Google My Business | All Traffic | Direct search count | |
| Adobe SiteCatalyst | All Traffic | Visits | |

*CTR—Click-through-rate

Online metrics for assessment associated with each channel are identified, step 306. Each channel may be associated with one or more online metrics as shown in Table 1. In a next step 308, a determination is made of which online metrics are used for causality measurement and assessment. A detecting unit may be configured to identify an appropriate Bayesian time-series model to be applied to the advertiser's data based on the channel(s) and the online metric(s) to be assessed. The Bayesian time-series models vary based on the online metric for assessment to detect causality. A modeling unit may be configured to determine an appropriate modeling approach based on the online metric(s) identified for assessment and estimate Bayesian time-series models for a data set.

Where the online metric identified for assessment is rate-based, causal modeling with market matching and dynamic time warping is applied, step 310. An example of a rate-based online metric includes click-through-rate for Google Adwords (non-brand terms) or Facebook ads. If the online metric is rate-based, such as click-through-rate from channels such as Google Adwords or Facebook Ads, the modeling technique used may be clicks used as a response variable matched on control online metrics namely impressions, spend and rank using dynamic time warping and causal impact modeling applied over a pre-intervention period and a post-intervention period for an intervention (introduction of a new marketing channel) analysis. Dynamic time warping allows for comparing series of values with each other that enables stretching or compressing two time-series locally to make one resemble the other. The distance between the two is computed, after stretching or compressing, by summing the distances of individual aligned elements.

In one embodiment, dynamic time warping may be used to pre-screen the identified online metrics to allow a user to select a pre-identified list of matching online metrics from by iterating through a list of probable candidates and ranking the candidates distance and/or correlation. The best control online metrics may be determined for each response variable by looping through all viable candidates in a parallel fashion and then ranking by distance and/or correlation. Applying dynamic time warping includes determining a warping curve ϕ such that D(X,Z) is minimized. The constraints for this function may include: monotonicity—ensures that the ordering of the indexes of the time-series are preserved—e.g., φx(t+1)>φx(t)φx(t+1)>φx(t); and warping limits—limits the length of permissible steps. Dynamic time warping allows the user to specify a maximum allowed time difference between two matched data points. This may be expressed as ∥φx(t)−φz(t)∥<L∥φx(t)−φz(t)∥<L, where L is the maximum allowed difference. Further description and details of a warping curve may be found in “Computing and Visualizing Dynamic Time Warping Alignments in R: The dtw Package,” by Toni Giorgino, which is hereby incorporated by reference in its entirety.

If the online metric identified for assessment is volume-based, causal modeling without market matching and dynamic time warping is applied, step 312. An example of a volume-based online metric includes search volume for Google Webmaster Tools. If the online metric is volume based, such as search volume traffic from Google webmaster tools, the impact is assessed using causal impact modeling without dynamic time warping applied for the pre-intervention period and the post-intervention period to arrive at the causality impact assessment.

As discussed above, based on the channels and online metrics, the system may decide whether to pre-screen and select matching online metrics to be used in a Bayesian time-series model as linear regression components (e.g., rate-based online metric) or to build a model without any linear regression components (e.g., volume-based online metric). Accordingly, the system may use one of a plurality of Bayesian time-series models comprised of a set of time-series models, wherein in each of said time-series model is built for each online metric for each paid and organic digital marketing channel for the advertiser. A Bayesian time-series model based on the assessed online metric may be used to detect causality. If the online metric assessed to detect causality is rate based (e.g., click through rate for Facebook Ads) from channels, the modeling technique used is clicks used as a response variable matched on control online metrics namely impressions, spend, and rank using dynamic time warping and causal impact modeling applied over the pre-intervention period and the post-intervention period for the intervention analyses. If the online metric assessed is volume based (e.g., search query volume from Google webmaster tools), the impact is assessed using causal impact modeling without any dynamic time warping applied for the pre-intervention period and the post-intervention period to arrive at the causality impact assessment. The Bayesian time-series model may be applied to a data set (including one or more matching variables and online metrics) to obtain a significant causality impact assessment of digital marketing channels for a given advertiser. Causality impact in the data set may be identified by evaluating a significant value across paid and organic channels simultaneously. Identifying causality may comprise determining whether the estimated impact is statistically significant, for example, at 95% significance.

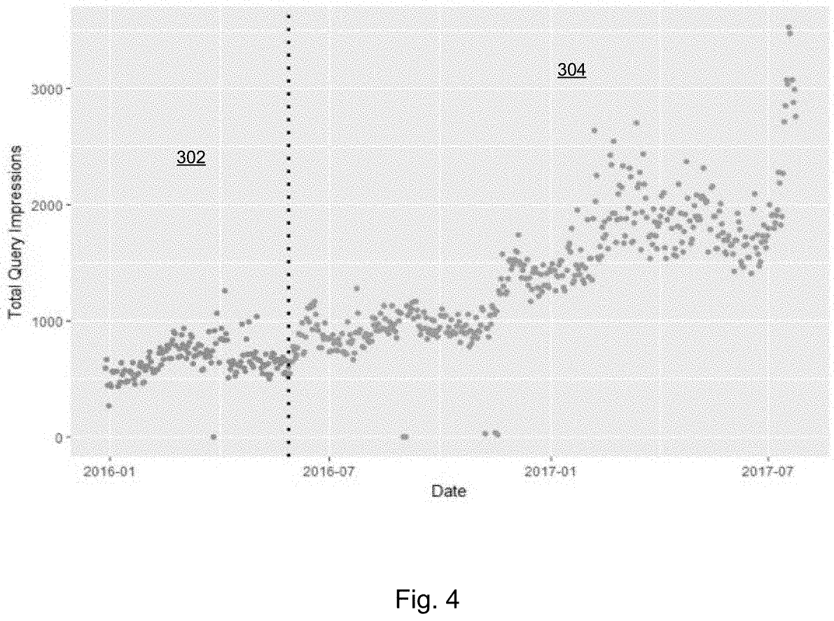

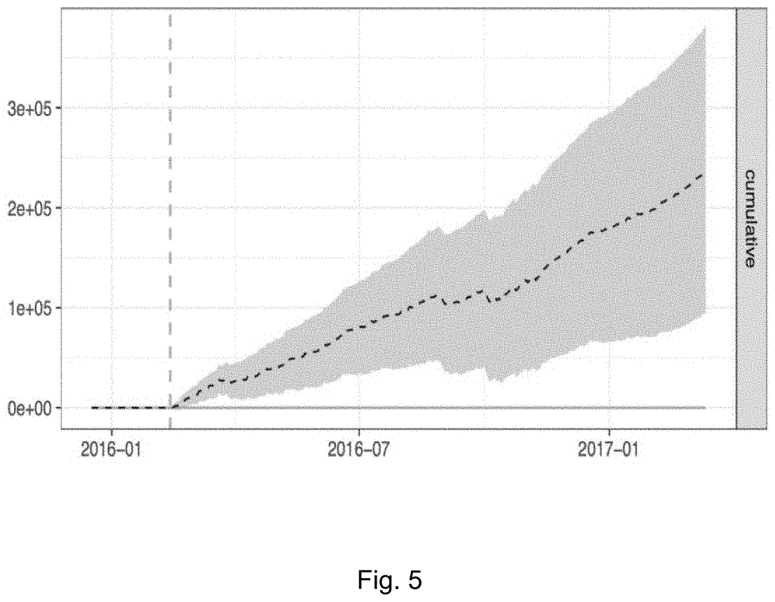

Optimal pre- and post-intervention periods are identified, step 314. The causality assessment for each online metric and channel may be assessed iteratively over incremental periods before and after intervention (e.g., introduction of marketing channel) using the Bayesian time-series model to identify optimal time windows to detect significant causality impact across paid and organic digital marketing channels, stopping at the minimal pre- and post-intervention period. The minimal pre- and post-intervention period identified is further validated by ensuring that significance for the causality assessment holds for the next incremental time period. A time window assessment may determine an optimal pre-intervention period and post-intervention period for each channel in incremental, for example, 30-day periods before and after intervention to identify two consecutive increments for statistically significant assessments, e.g., at 95% significance. Other period durations may also be used, such as 1-day, 7-day, 15-day, 60-day, or longer periods. For example, FIG. 4 presents an illustration of identified causality for search query impressions for an organic channel for a volume based online metric (search volume for Google Webmaster Tools). A region 402 may represent pre-intervention period online metric samples while region 404 may represent post period online metric samples. FIG. 5 presents identified causality for a paid channel for a rate based online metric, such as, non-brand term click through rate (e.g., using non-brand click volume market matched to impression volume and spend) for Google Adwords for non-brand terms.

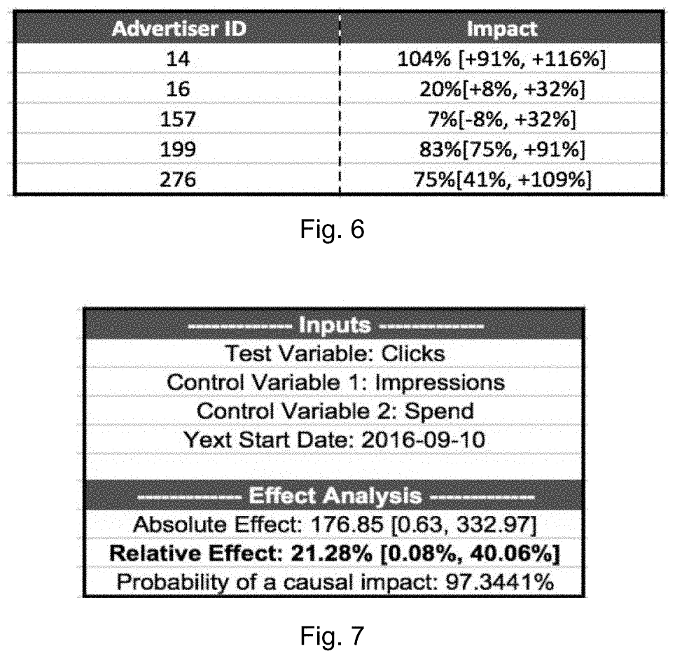

The Bayesian time-series model may use data prior to an intervention (e.g., introduction of a new marketing channel) and include the online metrics identified in step 308 as linear regression components. This model may then be used to predict the counterfactual, i.e., how the response online metric would have evolved after the intervention if the intervention had never occurred. Based on this model, counterfactual predictions (synthetic control series) for a post-intervention period can be generated based on the assumption that the intervention did not take place to quantify the causal impact of the intervention using, for example, spike-and-slab priors. For example, the Bayesian time-series model can be constructed using a response time-series (e.g., clicks) and a set of control time-series (e.g., clicks in non-affected markets or clicks on other sites). The difference between the synthetic control and a test market for the post-intervention period—which is the estimated impact of the event—can be calculated and compared to the posterior interval to gauge uncertainty. Once these predictions have been generated, they can be used to quantify the causal impact of the introduction of the new marketing channel introduced. FIG. 6 is an illustration of the identified causality for a channel for a metric for multiple advertisers.

According to one embodiment, the following Bayesian time-series model (state space mode) may be created for the pre-intervention period:

Yt=μt+xtβ+et,et˜N(0,σ2e)Yt=μt+xtβ+et,et˜N(0,σe2)μt+1=μt+vt,vt˜N(0,σ2v)μt+1=μt+vt,vt˜N(0,σv2).

Here, xt denotes control markets and μt is the local level term. The local level term defines how the latent state evolves over time and is often referred to as the unobserved trend. The linear regression term, xtβ, “averages” over the selected control online metrics. Once this model is in place, a synthetic control series may be created by predicting the values for the post period and then compare to the actual values to estimate the impact of the event. In order to gauge the believability of the estimated impact, posterior intervals can be created through sampling in a Bayesian fashion. The tail probability of a non-zero impact may also be computed. FIG. 7 presents posterior inference by causality assessment for click through rate for Google Adwords for non-brand terms across multiple advertisers using dynamic time warping and market matching with click volume as the response variable and two matching control online metrics (impressions and spend).

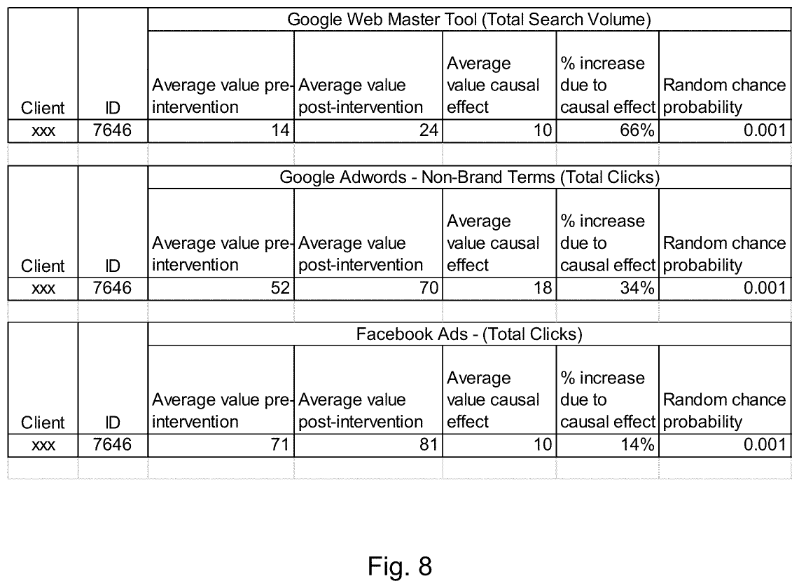

Causality assessment by period is determined, step 316. Once causality is detected for a particular online metric for a marketing channel, an optimal pre- and post-intervention period is assessed and evaluated. Assessment across the channels is reported, step 318. Reporting the assessment may include generating a rendering of charts, providing statistics, and recommendations. The Bayesian time-series model can estimate and report the significant causality assessment for each online metric modeled for an advertiser across a plurality of paid and organic digital marketing channels and two paid digital marketing channels. FIG. 8 illustrates final causality assessment across two paid channels (non-brand terms for Google Adwords and Facebook Ads both using click through rate) and one organic channel (Google Webmaster Tools using search volume) for an advertiser.

FIGS. 1 through 8 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps). In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer-readable program code) are stored in a main and/or secondary memory, and executed by one or more processors (controllers, or the like) to cause the one or more processors to perform the functions of the invention as described herein. In this document, the terms “machine readable medium,” “computer-readable medium,” “computer program medium,” and “computer usable medium” are used to generally refer to media such as a random-access memory (RAM); a read only memory (ROM); a removable storage unit (e.g., a magnetic or optical disc, flash memory device, or the like); a hard disk; or the like.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

What is claimed is:

1. A method performed by a data processing system comprising a processor and a memory for identifying causal impact of adding digital channels, the method comprising:
receiving, by the data processing system, data corresponding to online interactions with consumers based on online monitoring of an advertiser;
identifying, by the data processing system, digital channels associated with the online interactions with consumers;
identifying, by the data processing system, online metrics for assessment associated with the digital channels;
determining, by the data processing system, a Bayesian time-series model for the data based on the identified online metrics;
analyzing, by the data processing system, causality impact of an intervention for one or more paid digital and organic digital channels using the Bayesian time-series model;
identifying, by the data processing system, optimal pre- and post-intervention assessment time periods based on causality impact of the one or more paid digital and organic digital channels; and
generating, by the data processing system, a report including a causality assessment of the online metrics for the one or more paid digital and organic digital channels by period based on the causality impact during the optimal pre- and post-intervention time periods.

2. The method of claim 1, wherein analyzing causality impact further comprises determining whether the impact is statistically significant at 95% significance.

3. The method of claim 1, wherein a given online metric for assessment is click-through-rate, the Bayesian time-series model is based on using clicks as a response variable matched on control online metrics, and spend and rank using dynamic time warping for the identification of the optimal pre- and post-intervention assessment time periods.

4. The method of claim 1, wherein generating the report including the causality assessment further comprises estimating the causality assessment of the online metrics for at least two paid digital channels and one organic digital channel.

5. The method of claim 1, wherein identifying the optimal pre- and post-intervention assessment time periods further comprises assessing the causality impact iteratively over incremental 30-day periods before and after the intervention.

6. A system for identifying causal impact of adding digital marketing channels, the system comprising:
a memory device having executable instructions stored therein; and
a processing device, in response to the executable instructions, configured to:
receive data corresponding to online interactions with consumers based on online monitoring of an advertiser;
identify digital marketing channels associated with the online interactions with consumers;
identify online metrics for assessment associated with the digital marketing channels;
determine a Bayesian time-series model for the data based on the identified online metrics;
analyze causality impact of a marketing intervention for one or more paid digital marketing and organic digital marketing channels using the Bayesian time-series model;
identify optimal pre- and post-intervention assessment time periods based on causality impact of the one or more paid digital marketing and organic digital marketing channels; and
generate a report including a causality assessment of the online metrics for the one or more paid digital marketing and organic digital marketing channels by period based on the causality impact during the optimal pre- and post-intervention time periods.

7. The system of claim 6, wherein the processing device analyzes causality impact further comprises the processing device determines whether the impact is statistically significant at 95% significance.

8. The system of claim 6, wherein a given online metric for assessment is click-through-rate, the Bayesian time-series model is based on using clicks as a response variable matched on control online metrics, and spend and rank using dynamic time warping for the identification of the optimal pre- and post-intervention assessment time periods.

9. The system of claim 6, wherein the processing device generates the report including the causality assessment further comprises the processing device estimates the causality assessment of the online metrics for at least two paid digital marketing channels and one organic digital marketing channel.

10. The system of claim 6, wherein the processing device identifies the optimal pre- and post-intervention assessment time periods further comprises the processing device assesses the causality impact iteratively over incremental 30-day periods before and after the marketing intervention.

11. Non-transitory computer-readable media comprising program code that when executed by a programmable processor causes execution of a method for identifying causal impact of adding digital marketing channels, the computer-readable media comprising:
computer program code for receiving data corresponding to online interactions with consumers based on online monitoring of an advertiser;
computer program code for identifying digital marketing channels associated with the online interactions with consumers;
computer program code for identifying online metrics for assessment associated with the digital marketing channels;
computer program code for determining a Bayesian time-series model for the data based on the identified online metrics;
computer program code for analyzing causality impact of a marketing intervention for one or more paid digital marketing and organic digital marketing channels using the Bayesian time-series model;
computer program code for identifying optimal pre- and post-intervention assessment time periods based on causality impact of the one or more paid digital marketing and organic digital marketing channels; and
computer program code for generating a report including a causality assessment of the online metrics for the one or more paid digital marketing and organic digital marketing channels by period based on the causality impact during the optimal pre- and post-intervention time periods.

12. The non-transitory computer-readable media of claim 11, wherein the computer program code for analyzing causality impact further comprises computer program code for determining whether the impact is statistically significant at 95% significance.

13. The non-transitory computer-readable media of claim 11, wherein a given online metric for assessment is click-through-rate, the Bayesian time-series model is based on using clicks as a response variable matched on control online metrics, and spend and rank using dynamic time warping for the identification of the optimal pre- and post-intervention assessment time periods.

14. The non-transitory computer-readable media of claim 11, wherein the computer program code for generating the report including the causality assessment further comprises computer program code for estimating the causality assessment of the online metrics for at least two paid digital marketing channels and one organic digital marketing channel.

15. The non-transitory computer-readable media of claim 11, wherein the computer program code for identifying the optimal pre- and post-intervention assessment time periods further comprises computer program code for assessing the causality impact iteratively over incremental 30-day periods before and after the marketing intervention.
